(19) United States
(12) Patent Application Publication
(10) Pub. No.: US 2006/0129997 A1
(43) Pub. Date: Jun. 15, 2006

(54) Optimized layout for managed runtime environment

(76) Inventors: James M. Stichnoth, San Jose, CA (US); Brian T. Lewis, Palo Alto, CA (US)

Correspondence Address: INTEL CORPORATION, P.O. BOX 5326, SANTA CLARA, CA, 95056-5326, US

(21) Appl. No.: 11/011,428

(22) Filed: Dec. 13, 2004

(51) Int. Cl. G06F 9/44

(52) U.S. Cl. 717/127

(57) ABSTRACT

The present disclosure relates to an attempted optimized code layout utilizing a runtime managed environment and, more specifically, to attempting to optimize the layout of code, which utilizes a runtime managed environment, by attempting to place both callee and caller addresses within the same memory segment.

### BACKGROUND

1. Field

The present disclosure relates to attempting to optimize code layout utilizing a runtime managed environment and, more specifically, to attempting to optimize the layout of code, which utilizes a runtime managed environment, by attempting to place both callee and caller addresses within the same memory segment.

2. Background Information

Typically a traditional, also called Unmanaged, Runtime Environment involves compiling a human readable piece of source code into a machine readable program that utilizes what is known as “native” code to execute. This native code is often machine level instructions that are tailored specifically to the operating system and hardware the program is intended to run upon. The native code is not easily capable of being run on different operating system or hardware platform than was originally intended. Typically, in order to run the program on another hardware platform, the source code must be recompiled into native code targeted towards the new platform.

In this context, a Managed Runtime Environment (MRTE) is a platform that abstracts away the specifics of the operating system and the architecture running beneath them. Typically, a MRTE involves compiling a human readable piece of source code into a semi-machine/semi-human readable code that utilizes what is commonly known as bytecode; however, other names are used, such as, for example, Common Intermediate Language (CIL).

This bytecode may then be executed utilizing a virtual machine, which typically compiles the bytecode into native code and executes the native code. In order to run the bytecode on a variety of hardware and operating system platforms, no new recompilation of the human-readable source doe into bytecode is usually required. A virtual machine capable of interpreting the bytecode is all that is needed in order run the program on a given hardware platform.

Two common examples of MRTEs are the Java platform from Sun, and the Common Language Runtime championed by Microsoft. James Gosling, Bill Joy, Guy Steele, and Gilad Bracha. The Java Language Specification. Addison-Wesley, second ed., 2000. Tim Lindholm, and Frank Yellin. The Java Virtual Machine Specification. The Java Series. Addison Wesley Longman, Inc., second ed., 1999. ECMA-334 C# Language Specification, ECMA, December 2001. ECMA-335 Common Language Infrastructure (CLI), ECMA, December 2001.

In any application, but often most noticeably a large application, code layout decisions can be responsible for significant performance differences. Code layout is typically the way in which the program is stored within memory. These performance differences may result from stalls caused by instruction cache misses, translation look-aside buffer (TLB) misses, specifically instruction TLB (ITLB) misses, and branch mispredictions. There are many existing techniques for arranging basic code blocks with an application or method in order to decrease such performance reductions.

One of the known techniques for layout the program code in an optimum fashion is the Pettis-Hansen algorithm. K. Pettis and R. Hansen, Profile-Guided Code Positioning, Proceedings of the ACM SIGPLAN '90 Conference on Programming Language Design and Implementation, 1990, New York. This technique uses profiling information to identify hot caller-callee pairs, and arranges methods to keep frequent callers and callees close together.

In an Unmanaged Runtime Environment, rearranging the code is frequently difficult. The source code must typically be recompiled into new native code utilizing the proposed layout information. This is often impossible for the end user to accomplish as the source code for an application is rarely given to an end user. As a result, the code is rarely optimized based upon the way an end user actually uses the application.

Furthermore, the Pettis-Hansen algorithm does not attempt to determine precisely why the proximity of the two methods matters. As a result, the Pettis-Hansen algorithm may result in less than optimal layout choices. A new technique is needed that attempts to improve optimized code layout.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a flow chart illustrating an embodiment of a technique to optimize code layout in accordance with the disclosed subject matter;

FIG. 2 is a flow chart illustrating an embodiment of a technique to optimize code layout in accordance with the disclosed matter;

FIG. 3 is a flow chart illustrating an embodiment of a technique to optimize code layout in accordance with the disclosed matter;

FIG. 4 is a block diagram illustrating an embodiment of a technique to optimize code layout in accordance with the disclosed matter; and

FIG. 5 is a block diagram illustrating an embodiment of a system and an apparatus to optimize code layout in accordance with the disclosed matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

In this context, a caller-callee pair is a pair of memory addresses. The caller address is the address of the memory location causing a JUMP to a new address, the callee address. Often the caller and callee are parts of two separate methods. Frequently the callee address is the address of the first instruction in the callee method. In some embodiments, the caller address is considered the first address of the caller method; however, it is usually the JUMP instruction, or equivalent, causing the jump to the new callee memory address. A “hot” caller-callee pair is a frequently utilized pair.

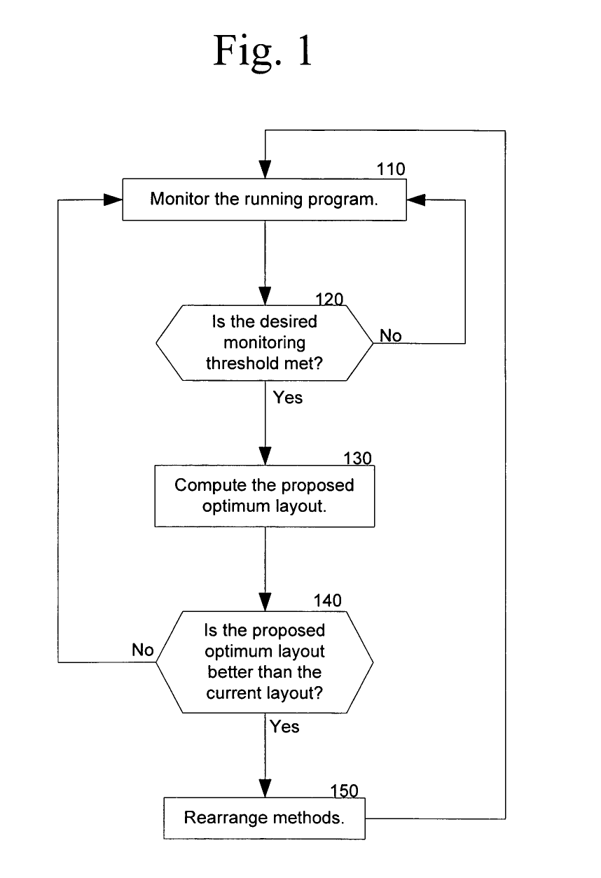

FIG. 1 is a flow chart illustrating an embodiment of a technique to optimize code layout. Block 110 illustrates that a program may be run and monitored for a period of time. Block 120 illustrates that this monitoring may continue until a certain threshold is reached.

Block 130 illustrates that once a sufficient about of information has been collected, a new proposed code layout may be computed. If the Pettis-Hansen algorithm is used, methods are examined to determine which methods frequently call each other, caller-callee pairs. The Pettis-Hansen algorithm then attempts to place these pairs physically close to one another.

Block 140 illustrates that the proposed layout may be compared against the existing layout. If the existing layout performs better than the proposed layout, the proposed layout may be abandoned and the technique attempted again, or the existing layout may be accepted as “the best.” Block 150 illustrates that if the proposed layout is accepted, the code may be rearranged.

Managed Runtime Environments (MRTEs) frequently differ from Unmanaged Runtime Environments (a.k.a. static compiled environments) in many ways. One key difference is that MRTEs offer the opportunity to dynamically profile the execution of an application and adapt the execution environment as runtime. This profiling information, in one embodiment, may be used by the executing program, often a virtual machine, to improve the performance of the application. In one embodiment, such adaptation can range from simple relocation of methods to a full recompilation (conversion of bytecode to native code) of the methods. The dynamic system may also, in an embodiment, modify the data or code layout such that the placement of objects and methods is changed relative to each other and reordering of the fields of the objects.

As mentioned above, in an application code layout decisions can be responsible for significant performance differences. These performance differences may result from stalls caused by instruction cache misses, translation look-aside buffer (TLB) misses, specifically instruction TLB (ITLB) misses.

Memory is typically arranged in memory segments, which, in this context, are manageable portions of memory. In one embodiment, such a memory segment may be an ITLB page. However, other memory segments may include cache lines, memory modules, memory bus channels, or other portions of memory.

Performance may be increased by laying out code in such a way that the number of stalls due to cache misses resulting from caller-callee pairs is reduced. In one embodiment of the disclosed technique, these cache misses may involve ITLB misses. In another embodiment, other cache memory segments may be involved. It is also contemplated that the code layout may be arranged such that callee-caller pairs are arranged such that memory bandwidth considerations are taken into account. For example, callee-caller pairs may be placed on different memory segments if the memory segments allow for the callee and caller to be accessed in parallel or via a technique that results in increased performance. While cache misses are discussed in detail in the illustrative embodiments, the disclosed matter is not limited to cache, specifically ITLB, misses or to placing the callee-caller pairs together. One skilled in the art will realize that other embodiments are possible.

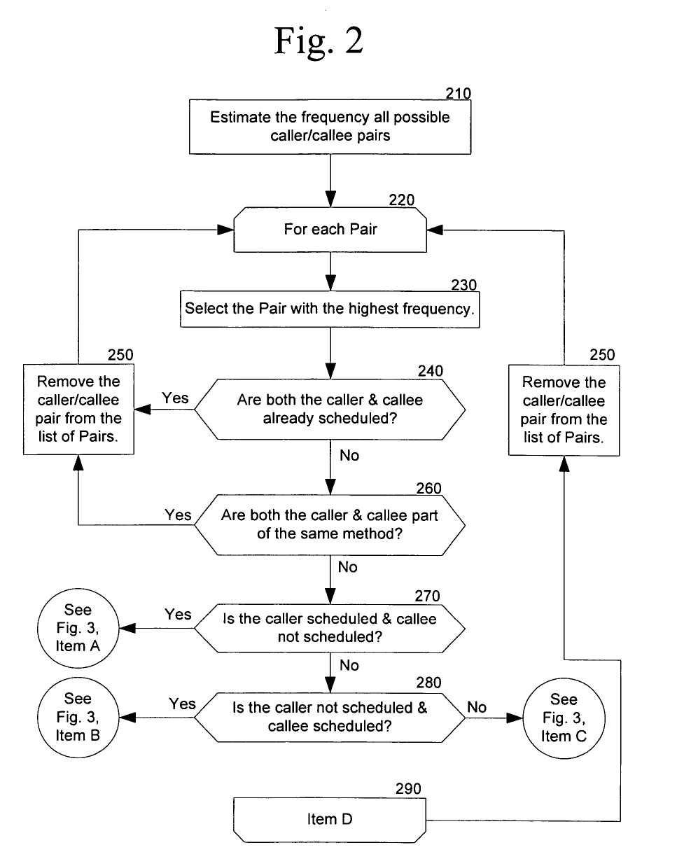

FIG. 2 is a flow chart illustrating an embodiment of a technique to optimize code layout in accordance with the disclosed matter. In one embodiment, the technique illustrated by FIGS. 2 & 3 may be used as part of Block 130 of FIG. 1. However, the technique is not limited to any one general optimization technique, such as the one illustrated by FIG. 1.

Block 210 illustrates the frequency of all possible caller-callee pairs may be estimated. In one embodiment, the estimation may result from monitoring the performance of the runtime behaviour of the program to be optimized. In one embodiment, the monitoring may occur as part of a MRTE. In a specific embodiment, the virtual machine or execution engine of the MRTE may provide information as part of the normal execution of the program to facilitate this estimation.

Block 220 illustrates that the technique may be executed for each caller-callee pair. However, in other embodiments, only a subset, for example the top 50%, of caller-callee pairs may be optimized. Although, the top 50% is merely an illustrative example and other subset criteria are within the scope of the disclosed subject matter.

Block 230 illustrates that, in one embodiment, the caller-callee pairs may be sorted for processing. For example, in a specific embodiment, the caller-callee pairs may be sorted from most frequent to least frequent. In another embodiment, the most frequent caller's may be processed first and then a secondary sorting done based upon the frequency of callees for each caller. However, other sorting techniques are contemplated and within the scope of the disclosed subject matter.

Block 240 illustrates that a check may be made to determine whether or not both the callee method and caller method have already been scheduled. If so, Block 250 illustrates that, in one embodiment, the caller-callee pair may be removed from the list and the next pair processed. In another embodiment, the current caller-callee pair may be judged to be more important than the previous pair which resulted in the scheduling of the two methods, if so, the methods may be re-scheduled. In yet another embodiment, the methods may be speculatively rescheduled or other results may occur. The disclosed subject matter is not limited to the illustrative embodiment of FIG. 2.

Block 260 illustrates that a check may be made to determine if the callee address and caller address are part of the same method. If so, Block 250 illustrates that, in one embodiment, the caller-callee pair may be removed from the list and the next pair processed.

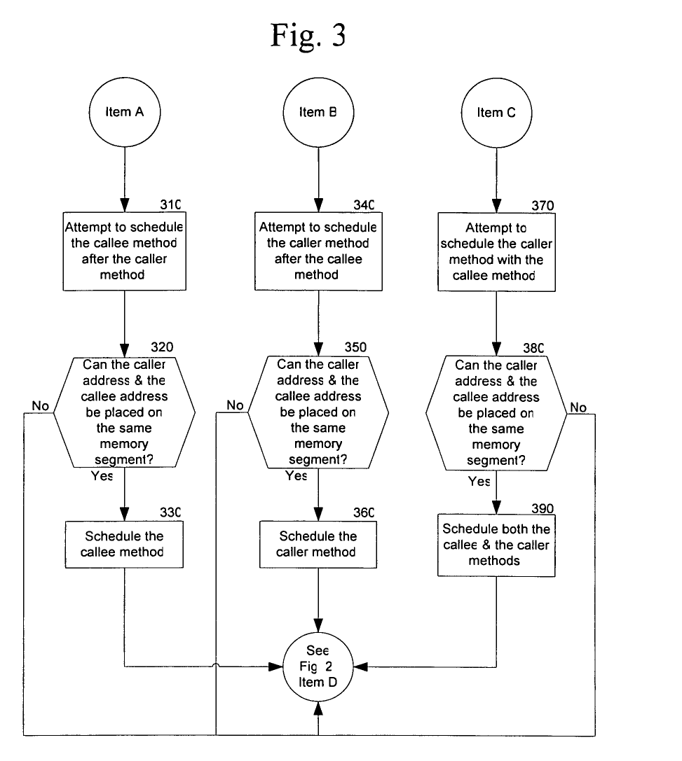

If not, Block 270 illustrates that a determination may be made whether or not the caller method is scheduled and the callee method is not scheduled. If so, an attempt may be made to schedule the callee method after the caller method, as illustrated by Block 310 of FIG. 3.

Block 320 illustrates that a determination may be made as to whether or not the caller address and the callee address can be placed within the same memory segment. If so, Block 330 illustrates that the callee address will be scheduled within the same memory segment as the caller address. Block 290 of FIG. 2 illustrates that after the attempt to schedule the method has either succeeded or failed, an attempt may be made to schedule the next caller-callee pair. In another embodiment, other attempts may be made to schedule the method. It is also understood that in one embodiment, after all pairs have been at least attempted to be scheduled, other more conventional techniques may be utilized to schedule the remaining unscheduled methods.

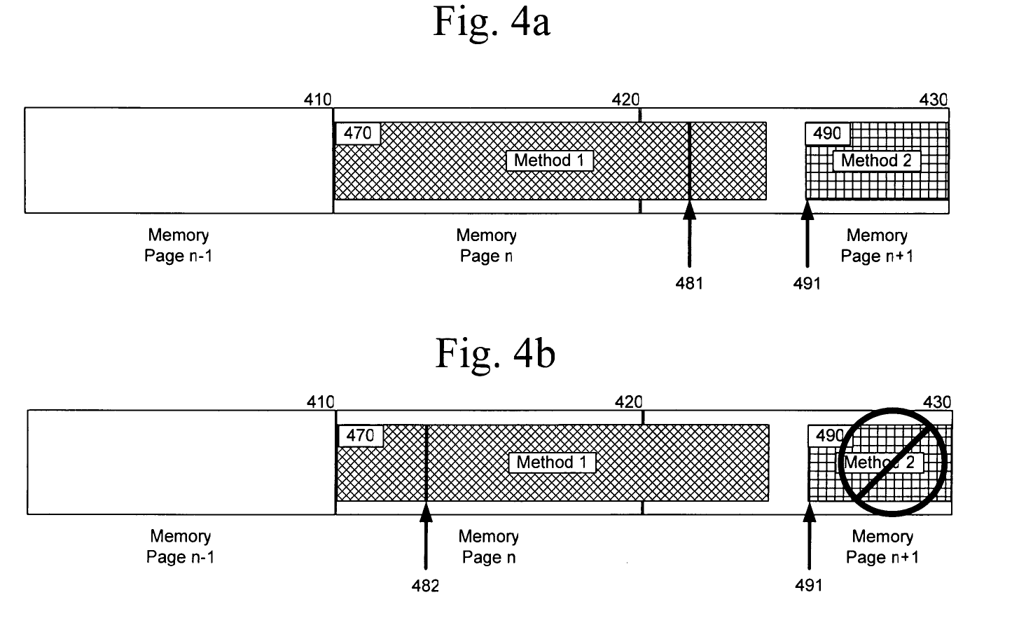

FIG. 4 is a block diagram illustrating an embodiment of a technique to optimize code layout in accordance with the disclosed matter. Specifically, FIG. 4 provides an illustrative embodiment of Blocks 310, 320 & 330 of FIG. 3.

Memory Segments 410, 420, & 430 illustrates three memory segments. In one embodiment the memory segments may be three ITLB pages. These memory segments may be contiguous and arranged in an ordered fashion. Caller method 470 may, in one embodiment, be large enough to consume all of memory segment 420 and a portion of memory segment 430. In the illustrative example of FIG. 4, the caller method may be scheduled.

FIG. 4a illustrates an embodiment where caller address 481 and callee address 491 represent a caller-callee pair. The callee address may be the first address of callee method 490. In FIG. 4a both the caller address and the callee address may be scheduled with the same memory segment, 430. In this embodiment, the determination of Block 320 of FIG. 3 would result in Block 330 being executed. The callee method would be scheduled within memory segment 430.

FIG. 4b illustrates an embodiment where caller address 482 and callee address 491 represent a second caller-callee pair. For purposes of this example, assume that caller method 470 has been scheduled as in FIG. 4a above, but that callee method 490 has yet to be scheduled. In FIG. 4b the caller address and the callee may not be scheduled within the same memory segment. The caller address occurs with memory segment 420, which is completely consumed by the caller method. It is understood that the memory segment need not be completely consumed with any given method merely unable to accommodate the callee method. As a result, in this embodiment, the determination of Block 320 of FIG. 3 would result in the callee method not being scheduled and another caller-callee pair being selected, as illustrated by Block 290 of FIG. 2. It is understood that this is merely one illustrative example and other examples and embodiments are within the scope of the disclosed subject matter.

Returning to the technique illustrated by FIGS. 2 & 3, Block 270 of FIG. 2 illustrates that a determination may be made as to whether or not the callee method is scheduled but the caller method is not. It is understood that other embodiments may exist in which the decision points, Blocks 240, 260, 270 & 280 may be reordered, removed, or other decision points introduced into the technique.

If the callee is scheduled and the caller is not, Block 340 of FIG. 3 illustrates that an attempt may be made to schedule the caller method after the callee method. Block 350 illustrates that a determination may be made as to whether or not the caller address and the callee address can be placed within the same memory segment. If so, Block 360 illustrates that the callee address will be scheduled within the same memory segment as the caller address. Block 290 of FIG. 2 illustrates that after the attempt to schedule the method has either succeeded or failed, an attempt may be made to schedule the next caller-callee pair. In another embodiment, other attempts may be made to schedule the method. It is also understood that in one embodiment, after all pairs have been at least attempted to be scheduled, other more conventional techniques may be utilized to schedule the remaining unscheduled methods

If both the caller and callee are unscheduled, which is the logical result if both Blocks 260 & 270 of FIG. 2 are answered in the negative, Block 370 of FIG. 3 illustrates that an attempt may be made to schedule both the caller method and the callee method. Block 380 illustrates that a determination may be made as to whether or not the caller address and the callee address can be placed within the same memory segment. If so, Block 390 illustrates that the callee address will be scheduled within the same memory segment as the caller address. Block 290 of FIG. 2 illustrates that after the attempt to schedule the methods have either succeeded or failed, an attempt may be made to schedule the next caller-callee pair. In another embodiment, other attempts may be made to schedule the methods. It is also understood that in one embodiment, after all pairs have been at least attempted to be scheduled, other more conventional techniques may be utilized to schedule the remaining unscheduled methods.

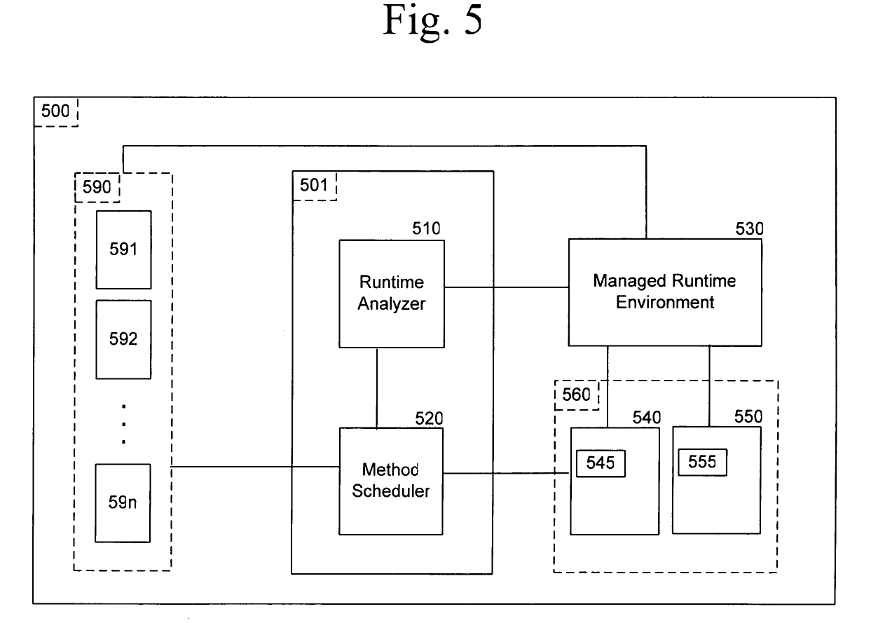

FIG. 5 is a block diagram illustrating an embodiment of a system 500 and an apparatus 501 to optimize code layout in accordance with the disclosed matter. In one embodiment, the apparatus may include a runtime analyzer 510 and a method scheduler 520. In one embodiment the system may include the apparatus, a memory 590, having memory segments, a managed runtime environment 530, and program code 560. Wherein, the program code has at least a caller method 540, having a caller address 545, and a callee method 550, having a callee address 555.

In one embodiment, the runtime analyzer 510 may be capable of monitoring the program code 560 as it is executed by the runtime environment 530. In the embodiment, the runtime analyzer may be capable of performing the actions described above in reference to Blocks 110, 120, & 140 of FIG. 1. In another embodiment, the runtime analyzer may be capable of estimating the frequency of the caller-callee pairs 545 & 555, as described above in reference to Block 210 of FIG. 2. In one embodiment, the runtime analyzer may be part of the managed runtime environment 530. In yet another embodiment, the runtime analyzer may be capable of analyzing a program code within an unmanaged runtime environment (not shown).

In one embodiment, the method scheduler may be capable of attempting to optimize the program code 560 layout within memory 590. In one embodiment, the optimized layout may involve placing as many caller address 545 and callee address 555 pair within a memory segment, such as memory segment 591, 592, or 59n, as possible. In one embodiment, the method scheduler may be capable of performing a technique substantially simpler to the one described above in reference to FIGS. 2 & 3.

In one embodiment, memory 590 may be capable of storing a program code 560. In one embodiment, the memory may include a number of memory segments, of which three 591, 592, & 59n are shown in FIG. 5. However, it is understood that the disclosed subject matter is not limited to any specific number of memory segments and that the memory segments may be of identical or various sizes. In various embodiments, the memory segments may include ITLB pages, cache lines, memory modules or other memory structures.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

The following is claimed:

1. A method for attempting to optimize code layout comprising:
generating a list of caller-callee address pairs, having a caller address and a callee address; and
for each caller-callee address pair within the list:
attempting to schedule the caller address and the callee address such that, for as many pairs as possible, both the caller address and the callee address are laid out within the same memory segment.

2. The method of claim 1, wherein attempting to schedule the caller address and the callee address comprises:
determining if both the caller address and the callee address are already scheduled;
if so, removing the caller-callee pair from the list; and
if not, attempting to schedule the caller address and the callee address such that, for as many pairs as possible, both the caller address and the callee address are laid out within the same memory segment.

3. The method of claim 2, wherein if not, attempting to schedule the caller address and the callee address comprises:
determining if the caller address is already scheduled; if so,
attempting to schedule the callee address after the caller address,
if possible scheduling the callee address within the same memory segment as the caller address.

4. The method of claim 2, wherein if not, attempting to schedule the caller address and the callee address comprises:
determining if the callee address is already scheduled;
if so,
attempting to schedule the caller address after the callee address,
if possible scheduling the caller address within the same memory segment as the callee address.

5. The method of claim 2, wherein if not, attempting to schedule the caller address and the callee address comprises:
determining if neither the caller address nor the callee address are already scheduled;
if neither are scheduled,
attempting to schedule both the callee address and the caller address,
if possible scheduling the callee address within the same memory segment as the caller address.

6. The method of claim 1, further comprising:
after attempting to schedule the list of caller-callee address pair, scheduling any other unscheduled portions of code.

7. The method of claim 6, wherein the memory segment is an instruction translation look-aside buffer (ITLB) page.

8. The method of claim 1, further comprising:
running the code to be laid out within a managed runtime environment;
monitoring the running code;
collecting data regarding the structure and functioning of the code;
computing a proposed layout for the code;
determining if the proposed layout is better than the current layout; and
if so, accepting the proposed layout; wherein, computing a proposed layout for the code includes the method of claim 1.

9. The method of claim 1, wherein generating a list of caller-callee address pairs includes:
sorting the list by the frequency that the caller-callee address pairs are accessed.

10. The method of claim 9, wherein generating a list of caller-callee address pairs includes:
generating a first list of all known caller-callee address pairs;
sorting the first list by the frequency that the caller-callee address pairs are accessed; and
generating a second list of caller-callee address pairs that are above a substantially predetermined frequency threshold.

11. An article comprising:
a machine accessible medium having a plurality of machine accessible instructions, for attempting to optimize code layout, wherein when the instructions are executed, the instructions provide for:
generating a list of caller-callee address pairs, having a caller address and a callee address; and
for each caller-callee address pair within the list:
attempting to schedule the caller address and the callee address such that, for as many pairs as possible, both the caller address and the callee address are laid out within the same memory segment.

12. The article of claim 11, wherein the instructions providing for attempting to schedule the caller address and the callee address comprises instructions providing for:
determining if both the caller address and the callee address are already scheduled;
if so, removing the caller-callee pair from the list; and
if not, attempting to schedule the caller address and the callee address such that, for as many pairs as possible, both the caller address and the callee address are laid out within the same memory segment.

13. The article of claim 12, wherein the instructions providing for if not, attempting to schedule the caller address and the callee address comprises instructions providing for:
determining if the caller address is already scheduled; if so,
attempting to schedule the callee address after the caller address,
if possible scheduling the callee address within the same memory segment as the caller address.

14. The article of claim 12, wherein the instructions providing for if not, attempting to schedule the caller address and the callee address comprises instructions providing for:
determining if the callee address is already scheduled;
if so,
attempting to schedule the caller address after the callee address,
if possible scheduling the caller address within the same memory segment as the callee address.

15. The article of claim 12, wherein the instructions providing for if not, attempting to schedule the caller address and the callee address comprises instructions providing for:
determining if neither the caller address nor the callee address are already scheduled;
if neither are scheduled,
attempting to schedule both the callee address and the caller address,
if possible scheduling the callee address within the same memory segment as the caller address.

16. The article of claim 11, further comprising instructions providing for:
after attempting to schedule the list of caller-callee address pair, scheduling any other unscheduled portions of code.

17. The article of claim 16, wherein the memory segment is an instruction translation look-aside buffer (ITLB) page.

18. The article of claim 11, further comprising instructions providing for:
running the code to be laid out within a managed runtime environment;
monitoring the running code;
collecting data regarding the structure and functioning of the code;
computing a proposed layout for the code;
determining if the proposed layout is better than the current layout; and
if so, accepting the proposed layout;
wherein, the instructions providing for computing a proposed layout for the code includes the instructions providing for in claim 1.

19. The article of claim 11, wherein the instructions providing for generating a list of caller-callee address pairs includes instructions providing for:
sorting the list by the frequency that the caller-callee address pairs are accessed.

20. The article of claim 19, wherein the instructions providing for generating a list of caller-callee address pairs includes instructions providing for:
generating a first list of all known caller-callee address pairs;
sorting the first list by the frequency that the caller-callee address pairs are accessed; and
generating a second list of caller-callee address pairs that are above a substantially predetermined frequency threshold.

21. An apparatus comprising:
a runtime analyzer, capable of:
monitoring a portion of code, having caller addresses and callee addresses, executing within a runtime environment,
collecting data regarding the structure and functioning of the code; and
a method scheduler, capable of attempting to optimize the layout of the portion of code;
wherein attempting to optimize the layout of the portion of code includes:
utilizing the data collected by the runtime analyzer,
generating a list of caller-callee address pairs, having a caller address and a callee address, and
for each caller-callee address pair within the list:
attempting to schedule the caller address and the callee address such that, for as many pairs as possible, both the caller address and the callee address are laid out within the same memory segment.

22. The apparatus of claim 21, wherein the method scheduler is further capable of when attempting to schedule the caller address and the callee address:
determining if both the caller address and the callee address are already scheduled;
if so, removing the caller-callee pair from the list; and
if not, attempting to schedule the caller address and the callee address such that, for as many pairs as possible, both the caller address and the callee address are laid out within the same memory segment.

23. The apparatus of claim 22, wherein the method scheduler is further capable of, if both the caller address and the callee address are not already scheduled:
determining if the caller address is already scheduled;
if so,
attempting to schedule the callee address after the caller address,
if possible scheduling the callee address within the same memory segment as the caller address.

24. The apparatus of claim 22, wherein the method scheduler is further capable of, if both the caller address and the callee address are not already scheduled:
determining if the callee address is already scheduled;
if so,
attempting to schedule the caller address after the callee address,
if possible scheduling the caller address within the same memory segment as the callee address.

25. The apparatus of claim 22, wherein the method scheduler is further capable of, if both the caller address and the callee address are not already scheduled:
determining if neither the caller address nor the callee address are already scheduled;
if neither are scheduled,
attempting to schedule both the callee address and the caller address,
if possible scheduling the callee address within the same memory segment as the caller address.

26. The apparatus of claim 21, the method scheduler is further capable of:
after attempting to schedule the list of caller-callee address pair, scheduling any other unscheduled portions of code.

27. The apparatus of claim 26, wherein the memory segment utilized by the method scheduler is an instruction translation look-aside buffer (ITLB) page.

28. The apparatus of claim 21, wherein, the runtime analyzer is further capable of:
running the code to be laid out within a managed runtime environment,
monitoring the running code, and
collecting data regarding the structure and functioning of the code; and the method scheduler is further capable of:
computing a proposed layout for the code;
determining if the proposed layout is better than the current layout; and
if so, accepting the proposed layout.

29. The apparatus of claim 21, wherein generating a list of caller-callee address pairs includes:
sorting the list by the frequency that the caller-callee address pairs are accessed.

30. The apparatus of claim 29, wherein generating a list of caller-callee address pairs includes:
generating a first list of all known caller-callee address pairs;
sorting the first list by the frequency that the caller-callee address pairs are accessed; and
generating a second list of caller-callee address pairs that are above a substantially predetermined frequency threshold.

31. A system comprising:
a memory, having a plurality of memory segments capable of storing a at least a subset of code;
a runtime analyzer, capable of:
monitoring a portion of code, having caller addresses and callee addresses, executing within a runtime environment,
collecting data regarding the structure and functioning of the code; and a method scheduler, capable of attempting to optimize the layout of the portion of code;
wherein attempting to optimize the layout of the portion of code includes:
utilizing the data collected by the runtime analyzer,
generating a list of caller-callee address pairs, having a caller address and a callee address, and
for each caller-callee address pair within the list:
attempting to schedule the caller address and the callee address such that, for as many pairs as possible, both the caller address and the callee address are laid out within the same memory segment.

32. The system of claim 31, wherein the method scheduler is further capable of when attempting to schedule the caller address and the callee address:
determining if both the caller address and the callee address are already scheduled;
if so, removing the caller-callee pair from the list; and
if not, attempting to schedule the caller address and the callee address such that, for as many pairs as possible, both the caller address and the callee address are laid out within the same memory segment.

33. The system of claim 32, wherein the method scheduler is further capable of, if both the caller address and the callee address are not already scheduled:
determining if the caller address is already scheduled;
if so,
attempting to schedule the callee address after the caller address,
if possible scheduling the callee address within the same memory segment as the caller address.

34. The system of claim 32, wherein the method scheduler is further capable of, if both the caller address and the callee address are not already scheduled:
determining if the callee address is already scheduled;
if so,
attempting to schedule the caller address after the callee address, if possible scheduling the caller address within the same memory segment as the callee address.

35. The system of claim 32, wherein the method scheduler is further capable of, if both the caller address and the callee address are not already scheduled:
determining if neither the caller address nor the callee address are already scheduled;
if neither are scheduled,
attempting to schedule both the callee address and the caller address,
if possible scheduling the callee address within the same memory segment as the caller address.

36. The system of claim 31, the method scheduler is further capable of:
after attempting to schedule the list of caller-callee address pair, scheduling any other unscheduled portions of code.

37. The system of claim 36, wherein the memory segment utilized by the method scheduler is an instruction translation look-aside buffer (ITLB) page.

38. The system of claim 31, further including:
a runtime management environment, capable of running the code to be laid out; and
wherein
the runtime analyzer is further capable of:
monitoring the running code, and
collecting data regarding the structure and functioning of the code; and the method scheduler is further capable of:
computing a proposed layout for the code;
determining if the proposed layout is better than the current layout; and if so, accepting the proposed layout.

39. The system of claim 31, wherein generating a list of caller-callee address pairs includes:
sorting the list by the frequency that the caller-callee address pairs are accessed.

40. The system of claim 39, wherein generating a list of caller-callee address pairs includes:
generating a first list of all known caller-callee address pairs;
sorting the first list by the frequency that the caller-callee address pairs are accessed; and
generating a second list of caller-callee address pairs that are above a substantially predetermined frequency threshold.
